(19) United States
(12) Patent Application Publication
(10) Pub. No.: US 2025/0247723 A1
(43) Pub. Date: Jul. 31, 2025

(54) TECHNIQUES FOR DETERMINING CHANNEL MEASUREMENTS BY A NETWORK-CONTROLLED REPEATER

(71) Applicant: QUALCOMM Incorporated, San Diego, CA (US)

(72) Inventors: Jianghong LUO, Skillman, NJ (US); Navid ABEDINI, Basking Ridge, NJ (US); Naeem AKL, BRIDGEWATER, NJ (US); Junyi LI, Fairless Hills, PA (US)

(21) Appl. No.: 18/424,180

(22) Filed: Jan. 26, 2024

(51) Int. Cl. H04W 24/10; H04B 17/318; H04L 5/00; H04W 72/20

(52) U.S. Cl. CPC H04W 24/10; H04B 17/328; H04L 5/001; H04W 72/20

(57) ABSTRACT

Methods, systems, and devices for wireless communications are described. Techniques described herein provide channel measurements determined by a network-controlled repeater (NCR). In some examples, the NCR may receive, from a network entity via a serving cell associated with the NCR, control signaling indicating the one or more sub-bands for a channel measurement on a component carrier associated with a network-controlled forwarding. The one or more sub-bands may be at least partially non-overlapping with a frequency range associated with the serving cell. The NCR may transmit, to the network entity the channel measurement associated with the one or more sub-bands. The NCR may relay signaling over the one or more sub-bands based at least in part on transmitting the channel measurement.

### FIELD OF TECHNOLOGY

The following relates to wireless communications, including techniques for determining channel measurements by a network-controlled repeater.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for determining channel measurements by a network-controlled repeater (NCR). For example, the described techniques provide for the NCR to perform channel measurement on a component carrier associated with network-controlled forwarding. In some examples, the NCR may receive, from a network entity via a serving cell associated with the NCR, control signaling indicating one or more sub-bands for a channel measurement on a component carrier associated with network-controlled forwarding. The one or more sub-bands may be at least partially non-overlapping with a frequency range associated with the serving cell. The NCR may transmit, to the network entity, the channel measurement associated with the one or more sub-bands. The NCR may relay signaling over the one or more sub-bands based on transmitting the channel measurement.

A method for wireless communications by a NCR is described. The method may include receiving, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell, transmitting, to the network entity based on receiving the first control signaling, the channel measurement associated with the one or more sub-bands, and relaying signaling over the one or more sub-bands based on transmitting the channel measurement.

A NCR for wireless communications is described. The NCR may include one or more memories storing processor executable code, and one or more processors coupled with the one or more memories. The one or more processors may individually or collectively be operable to execute the code to cause the NCR to receive, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell, transmit, to the network entity based on receiving the first control signaling, the channel measurement associated with the one or more sub-bands, and relay signaling over the one or more sub-bands based on transmitting the channel measurement.

Another NCR for wireless communications is described. The NCR may include means for receiving, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell, means for transmitting, to the network entity based on receiving the first control signaling, the channel measurement associated with the one or more sub-bands, and means for relaying signaling over the one or more sub-bands based on transmitting the channel measurement.

A non-transitory computer-readable medium storing code for wireless communications is described. The code may include instructions executable by one or more processors to receive, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell, transmit, to the network entity based on receiving the first control signaling, the channel measurement associated with the one or more sub-bands, and relay signaling over the one or more sub-bands based on transmitting the channel measurement.

In some examples of the method, networks, and non-transitory computer-readable medium described herein, the one or more sub-bands may be a frequency range, a radio frequency band, the component carrier, or a bandwidth part of the component carrier.

Some examples of the method, networks, and non-transitory computer-readable medium described herein may further include operations, features, means, or instructions for receiving, from the network entity based on the channel measurement, second control signaling indicating control information associated with the network-controlled forwarding via the one or more sub-bands.

In some examples of the method, networks, and non-transitory computer-readable medium described herein, the control information indicates an amplification gain, a transmission power, an on-off operation, one or more backhaul beams, one or more access-link beams, a quantity of antenna elements, or a combination thereof.

In some examples of the method, networks, and non-transitory computer-readable medium described herein, the channel measurement includes a received signal strength indicator in an intermediate frequency domain or a radio frequency domain.

In some examples of the method, networks, and non-transitory computer-readable medium described herein, the channel measurement includes a precoding matrix indicator or a channel quality indicator.

Some examples of the method, networks, and non-transitory computer-readable medium described herein may further include operations, features, means, or instructions for receiving, from the network entity based on transmitting the channel measurement, third control signaling indicating the one or more sub-bands associated with a scheduled forwarding operation and adjusting an amplification gain associated with the scheduled forwarding operation.

A method for wireless communications by a network entity is described. The method may include outputting, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell, obtaining, from the network entity based on transmitting the first control signaling, the channel measurement associated with the one or more sub-bands, and outputting signaling over the one or more sub-bands based on transmitting the channel measurement.

A network entity for wireless communications is described. The network entity may include one or more memories storing processor executable code, and one or more processors coupled with the one or more memories. The one or more processors may individually or collectively be operable to execute the code to cause the network entity to output, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell, obtain, from the network entity based on transmitting the first control signaling, the channel measurement associated with the one or more sub-bands, and output signaling over the one or more sub-bands based on transmitting the channel measurement.

Another network entity for wireless communications is described. The network entity may include means for outputting, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell, means for obtaining, from the network entity based on transmitting the first control signaling, the channel measurement associated with the one or more sub-bands, and means for outputting signaling over the one or more sub-bands based on transmitting the channel measurement.

A non-transitory computer-readable medium storing code for wireless communications is described. The code may include instructions executable by one or more processors to output, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell, obtain, from the network entity based on transmitting the first control signaling, the channel measurement associated with the one or more sub-bands, and output signaling over the one or more sub-bands based on transmitting the channel measurement.

In some examples of the method, network entities, and non-transitory computer-readable medium described herein, the one or more sub-bands may be a frequency range, a radio frequency band, the component carrier, or a bandwidth part of the component carrier.

Some examples of the method, network entities, and non-transitory computer-readable medium described herein may further include operations, features, means, or instructions for outputting, to the NCR based on obtaining the channel measurement, second control signaling indicating control information associated with the network-controlled forwarding via the one or more sub-bands.

In some examples of the method, network entities, and non-transitory computer-readable medium described herein, the control information indicates an amplification gain, a transmission power, an on-off operation, one or more backhaul beams, one or more access-link beams, a quantity of antenna elements.

Some examples of the method, network entities, and non-transitory computer-readable medium described herein may further include operations, features, means, or instructions for outputting, to a user equipment via the network-controlled forwarding based on obtaining the channel measurement, third control signaling indicating a configuration of a frequency domain resources associated with a second channel measurement or associated with a communication.

Some examples of the method, network entities, and non-transitory computer-readable medium described herein may further include operations, features, means, or instructions for outputting, to a user equipment via the network-controlled forwarding based on obtaining the channel measurement, third control signaling indicating a configuration of a modulation and coding scheme for communication of data with the user equipment via the network-controlled forwarding.

Some examples of the method, network entities, and non-transitory computer-readable medium described herein may further include operations, features, means, or instructions for adjusting a transmission power associated with the signaling based on the channel measurement.

### BRIEF DESCRIPTION OF THE DRAWINGS

FIG. 1 shows an example of a wireless communications system that supports techniques for determining channel measurements by a network-controlled repeater (NCR) in accordance with one or more aspects of the present disclosure.

FIG. 2 shows an example of a wireless communications system that supports techniques for determining channel measurements by a NCR in accordance with one or more aspects of the present disclosure.

FIG. 3 shows an example of a process flow that supports techniques for determining channel measurements by a NCR in accordance with one or more aspects of the present disclosure.

FIGS. 4 and 5 show block diagrams of devices that support techniques for determining channel measurements by a NCR in accordance with one or more aspects of the present disclosure.

FIG. 6 shows a block diagram of an action response component that supports techniques for determining channel measurements by a NCR in accordance with one or more aspects of the present disclosure.

FIG. 7 shows a diagram of a system including a device that supports techniques for determining channel measurements by a NCR in accordance with one or more aspects of the present disclosure.

FIGS. 8 and 9 show block diagrams of devices that support techniques for determining channel measurements by a NCR in accordance with one or more aspects of the present disclosure.

FIG. 10 shows a block diagram of a communications manager that supports techniques for determining channel measurements by a NCR in accordance with one or more aspects of the present disclosure.

FIG. 11 shows a diagram of a system including a device that supports techniques for determining channel measurements by a NCR in accordance with one or more aspects of the present disclosure.

FIGS. 12 through 14 show flowcharts illustrating methods that support techniques for determining channel measurements by a NCR in accordance with one or more aspects of the present disclosure.

### DETAILED DESCRIPTION

Some wireless communications systems may include a network-controlled repeater (NCR). The NCR may include an NCR Forwarding (NCR-Fwd) functional entity and an NCR mobile termination (NCR-MT) functional entity. The NCR-Fwd may perform amplify-and-forward of uplink and downlink radio frequency signals between a network entity and a user equipment (UE). The NCR-Fwd may forward multiple component carriers associated with the network entity. The NCR-MT may communicate, with the network entity via a control link, side control information, such as control and status signaling. The behavior of the NCR-Fwd may be controlled according to the side control information received by the NCR-MT from the network entity. In some examples, the UE may be configured by the network entity to perform channel measurements over different sub-bands of the multiple component carriers associated with the network, and the UE may transmit the channel measurements to the network entity. The UE performing and reporting channel measurements may consume power and processing capacity of the UE and may consume signaling overhead.

Techniques described herein for determining channel measurements by a NCR may efficiently use available resources. In some examples, the NCR may receive, from the network entity via a serving cell associated with the NCR, control signaling indicating one or more sub-bands for a channel measurement on a component carrier associated with a network-controlled forwarding. The one or more sub-bands may be at least partially non-overlapping with a frequency range associated with the serving cell. The NCR may transmit, to the network entity, the channel measurement associated with the one or more sub-bands. The NCR may relay signaling over the one or more sub-bands based part on the channel measurement. In some examples, the NCR may receive, from the network entity, control signaling indicating control information associated with the network control forwarding via the one or more sub-bands. For example, the control information may indicate an amplification gain, a transmission power, an on-off operation, one or more backhaul beams, one or more access-link beams, a quantity of antenna elements, or a combination thereof. In some examples, the network entity may output, to a UE via the network-controlled forwarding based on the channel measurement, control signaling indicating a configuration of a frequency domain resource for communication.

Aspects of the disclosure are initially described in the context of wireless communications systems. Aspects of the disclosure are also described in context of a process flow. Aspects of the disclosure are further illustrated by and described with reference to apparatus diagrams, system diagrams, and flowcharts that relate to techniques for determining channel measurements by a NCR.

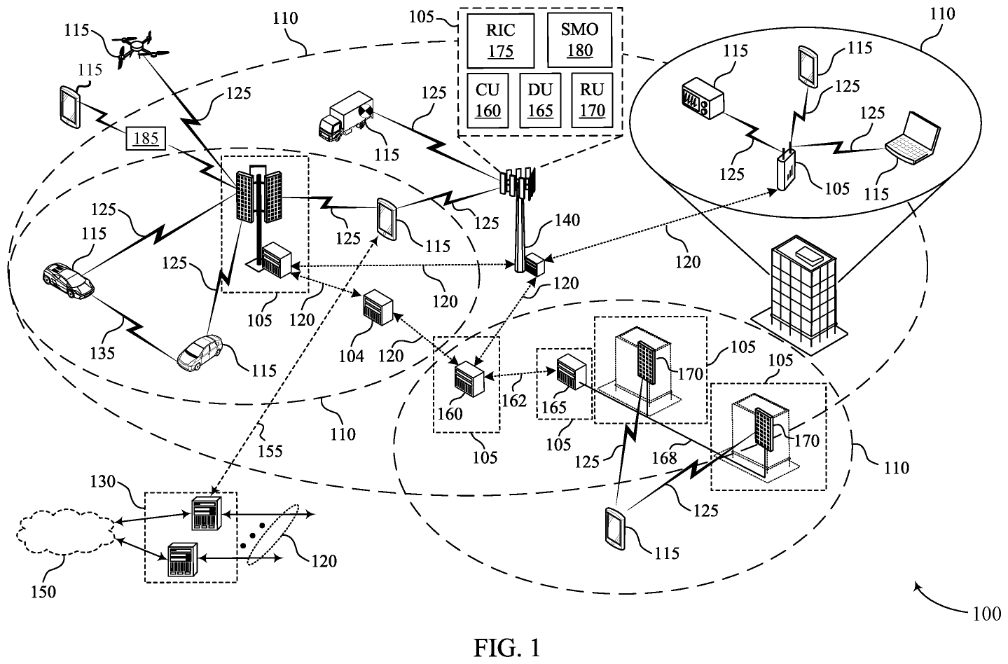

FIG. 1 shows an example of a wireless communications system 100 that supports techniques for determining channel measurements by a NCR in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for determining channel measurements by a NCR as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1. The UE 115 may communicate with the network entity 105 through an NCR 185.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications systems may include an NCR. The NCR may include an NCR-Fwd functional entity and an NCR-MT functional entity. The NCR-Fwd may perform amplify-and-forward of uplink and downlink radio frequency signals between a network entity 105 and a UE. The NCR-Fwd may forward multiple component carriers associated with the network entity 105. The NCR-MT may communicate, with the network entity 105 via a control link, side control information, such as control and status signaling. The behavior of the NCR-Fwd may be controlled according to the side control information received by the NCR-MT from the network entity 105. In some examples, the UE 115 may be configured by the network entity 105 to perform channel measurements over different sub-bands of the multiple component carriers associated with the network, and the UE 115 may transmit the channel measurements to the network entity 105. The UE 115 performing and reporting channel measurements may consume power and processing capacity of the UE 115 and may consume signaling overhead.

Techniques for determining channel measurements by a NCR may efficiently use available resources. In some examples, the NCR may receive, from the network entity 105 via a serving cell associated with the NCR, control signaling indicating one or more sub-bands for a channel measurement on a component carrier associated with a network-controlled forwarding. The one or more sub-bands may be at least partially non-overlapping with a frequency range associated with the serving cell. The NCR may transmit, to the network entity, the channel measurement associated with the one or more sub-bands. The NCR may relay signaling over the one or more sub-bands based on the channel measurement. In some examples, the NCR may receive, from the network entity, control signaling indicating control information, and the control information may be associated with the network control forwarding over the one or more sub-bands. For example, the control information may indicate an amplification gain, a transmission power, an on-off operation, one or more backhaul beams, one or more access-link beams, a quantity of antenna elements, or a combination thereof. In some examples, network entity 105 may output, to a UE 115 via the network-controlled forwarding based on the channel measurement, control signaling indicating a configuration of a frequency domain resource for communication.

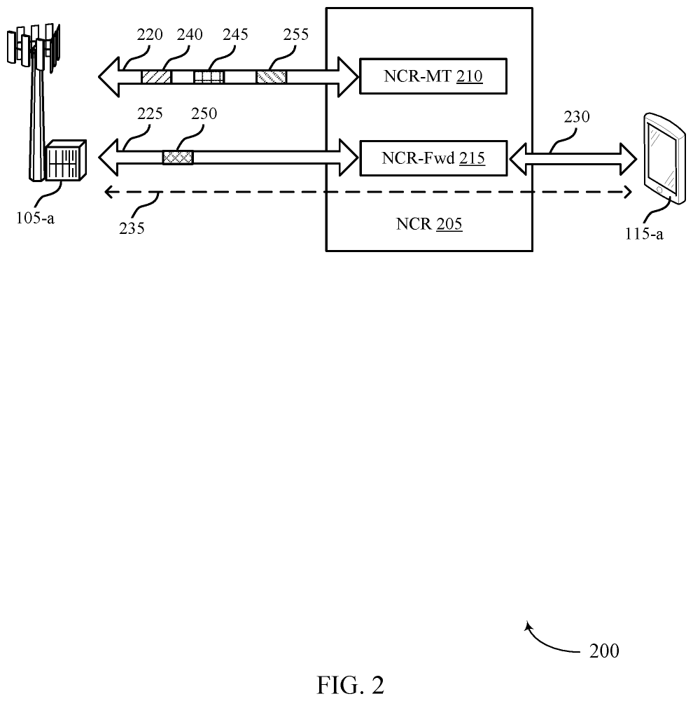

FIG. 2 shows an example of a wireless communications system 200 that supports techniques for determining channel measurements by an NCR in accordance with one or more aspects of the present disclosure. The wireless communications system 200 may implement or be implemented by aspects of the wireless communications system 100 as described in FIG. 1. For example, the wireless communications system 200 may support signaling and configurations for determining channel measurements by the NCR. The wireless communications system 200 may include a network entity 105-a and a UE 115-a, which may be examples of network entities 105 and UEs 115 as described with reference to FIG. 1.

In some examples, the wireless communications system 200 may include an NCR 205, and the NCR 205 may include an NCR-MT 210 and an NCR-Fwd 215. In some aspects, network entity 105-a may communicate with the NCR-MT 210 via a control link 220. The UE 115-a may communicate with the network entity 105-a via an access link 230 (e.g., a Uu link) and a backhaul link 225. The NCR-Fwd 215 may perform amplify-and-forward of uplink and downlink radio frequency signals (e.g., uplink control signals, uplink data signals, downlink control signals and downlink data signals) between the network entity 105-a and the UE 115-a via the backhaul link 225 and the access link 230. The connection between network entity 105-a and the UE 115-a through the NCR 205 may be considered a UE access link 235, and the NCR 205 may be transparent to the UE 115-a. Additionally, the link between the network entity 105-a and the NCR 205 and the link between the NCR 205 and the UE 115-a may be maintained simultaneously. The NCR-MT 210 may exchange side control information with the network entity 105-b via the control link 220, and the control link 220 may be based on an NR Uu interface. The behavior of the NCR-Fwd 215 may be controlled according to the side control information received by the NCR-MT 210 from the network entity 105-a. The NCR 205 may provide inband RF repeaters for coverage extension on FR1 or FR2 or both, and the forwarding by the NCR 205 may be a single hop. The NCR 205 may be stationary or mobile.

The behavior of the NCR-Fwd 215 may be controlled according to the side control information received by the NCR-MT 210 from the network entity 105-b. In some examples, the side control information or side control configuration exchanged between the network entity 105-b and the NCR-MT 210 may include one or more of beam information for the access link 230 and the backhaul link 225, TDD uplink or downlink configuration, on-off indication for the NCR-Fwd 215. For example, the side control information may include an access link beam indication, such as aperiodic beam indication via downlink control information (DCI) and RRC, semi-persistent beam indication via medium access control-control element (MAC-CE) and RRC, or periodic beam indication via RRC. The access link beam indication may indicate one or multiple beam indices along with associated time resources. The access beam indication may include a beam index referring to orbital angular momentum (OAM) configured access beams. The side control information may include a backhaul beam indication, such as an optional beam indication that may be semi-persistent via MAC-CE. The optional beam indication may include a beam index that refers to RRC configured beams of the NCR-MT 210. The backhaul beam indication may include predefined rules in case no explicit indication is provided. In some cases, the sidelink control information may include on-off indication for the NCR-Fwd 215 with the on state being implicitly indicated via access link beam indication, and the NCR-Fwd may be off if not indicated as on or within semi-static flexible symbols. In some cases, the TDD information and transmission and reception timing references of the NCR-Fwd 215 may be provided by the available information of the NCR-MT 210 when no new side control information is provided. The access link beam configuration information for the NCR-Fwd 215 may be provided by the OAM that includes information characterizing beams to the network entity 105-a and NCR 205. In some cases, the beam characterization (e.g., quantity of beams, spatial information, and direction) may be up to implementation.

In some examples, a frequency-selective carrier may include different sub-bands with different channel conditions. In existing channel state information (CSI) frameworks, the UE 115-a may be configured by the network entity 105-a to perform channel measurements over different sub-bands and to report the channel measurements to the network entity 105-a. A sub-band may be of a frequency range, a radio frequency band, the component carrier, or a bandwidth part of the component carrier. Using the reported channel measurements, the network entity 105-a may perform frequency-selective scheduling, such as selecting one or more sub-bands with less interference for data communication. In some cases, the network entity 105-a may perform frequency-dependent downlink power control (e.g., classic water-filling) based on the reported channel measurements.

In some examples, the NCR-MT 210 may be configured by the network entity 105-a to perform sub-band channel measurements, and the channel measurement performed by the NCR-MT 210 may be on the serving cell(s) of the NCR-MT 210. The backhaul link 225 may be partially or non-overlapping with the serving cell(s) of NCR-MT 210, especially for out-of-band repeaters. The NCR-Fwd 215 may forward multiple component carriers of the network entity 105-a, and the serving cell(s) of the NCR-MT 210 may be one of the forwarded component carriers of the network entity 105-a or a subset (e.g., partially overlapping) of the forwarded component carriers of the network entity 105-a. In some cases, the serving cell(s) of the NCR-MT 210 may be non-overlapping with the forwarded component carriers. For example, the NCR-Fwd 215 may forward FR2 component carriers of the network entity 105-a, and the NCR-MT 210 may be connected to a FR1 cell (e.g., non-overlapping). In some examples, techniques for determining channel measurements by the NCR 205 may support sub-band based channel measurements over the backhaul link 225 of the NCR-Fwd 215, and the backhaul link 225 may be partially or non-overlapping with the serving cell of the NCR-MT 210.

In some examples, the network entity 105-a may select a preliminary sub-band for the UE 115-a based on the channel measurements or feedback of the backhaul link 225 to save CSI feedback overhead of the UE 115-a. For example, the network entity 105-a may configure the UE 115-a (or other UEs) to perform and report channel measurements on sub-bands with good channel conditions associated with the backhaul link 225. For sub-bands with poor channels of the backhaul link 225, the end-to-end composite channel of the UE access link 235 may also be poor. The backhaul link 225 may typically be stationary and may require less frequent channel measurement reports than the access link 230 of the UE 115-a. Benefits of the sub-band based channel feedback of the backhaul link 225 may be a reduction of the power consumption of the UE 115-a, a reduction of the processing of the UE 115-a, and a reduction of the signaling overhead of the UE 115-a.

In some examples, the network entity 105-a may control transmit power based on the channel feedback associated with the backhaul link 225 to avoid power amplifier (PA) saturation at the NCR 205. Compared to an alternative solution of the NCR 205 autonomously adjusting a gain to avoid PA saturation, the network entity 105-a adjusting the transmit power may achieve the same goal with a less transmit power of the network entity 105-a. In some cases, the network entity 105-a may perform frequency-dependent power control based on the sub-band based channel measurement over backhaul link 225. Benefits of the sub-band based channel feedback of the backhaul link 225 may be network power savings and simplification of the power implementation at the NCR 205 (e.g., no aggressive automatic gain control (AGC) by the NCR 205).

In some examples, the sub-band based channel feedback of the backhaul link 225 may provide a more efficient operation for the NCR 205 with frequency-translation capability. For example, the network entity 105-a may transmit a signal on a first sub-band (e.g., the strongest backhaul sub-band) selected based on channel feedback for the backhaul link 225, and the network entity 105-a may transmit signaling to the NCR 205 requesting the NCR 205 to shift frequency to a second sub-band for access link 230 (e.g., the strongest sub-band of the access link 230). Benefits of the sub-band based channel feedback of the backhaul link 225 may be better resource utilization and larger achieved spectral efficiency.

In some examples, the network entity 105-a may implement more efficient sub-band based control for the NCR 205 with advanced capability of frequency-dependent forwarding based on the channel feedback for backhaul link 225. The NCR 205 may have advanced capability of frequency-dependent forwarding, for example, the NCR 205 may have one or more filters that can separate signals in the frequency-domain with granularity of RF band, RF component carrier, a fraction of a component carrier (e.g., bandwidth part), and so on. Although frequency-dependent forwarding may be performed by the NCR 205 autonomously, network based control may be more efficient because the network entity 105-a may have more information than the NCR 205 to improve the system performance. For example, the network entity 105-a may have both end-to-end channel feedback from the UE 115-a (or other UEs) and the backhaul link channel feedback from the NCR-MT 210. Additionally, the network entity 105-a may have better knowledge on interference among its scheduled direct or indirect UEs and the NCRs under its control. Further, the network entity 105-a may also obtain coordination messaging from other network entities for interference control.

In some cases, the network entity 105-a may determine different parameters of a NCR forward function over different sub-bands based on channel feedback of the backhaul link 225 to maximize performance metrics. For example, the performance metrics may be end-to-end signal-to-interference plus noise ratio (SINR), spectral efficiency, network energy efficiency including energy efficiency of the network entity 105-a, NCR 205, or UE 115-a. Based on channel measurement reports from the UE 115-a (or other remote UEs), the NCR 205, or a combination thereof, the network entity 105-a may decide to schedule a direct UE on a first sub-band, and an indirect UE via the NCR 205 on a second sub-band for improving system spectrum efficiency. For example, the network entity 105-a may transmit control signaling to control the NCR 205 to turn on for the second sub-band for forwarding.

In some examples, the NCR 205 may be configured to perform sub-band based channel measurements over the backhaul link 225 of the NCR-Fwd 215. For example, the NCR 205 may receive, from the network entity 105-a, control signaling 240 indicating one or more sub-bands for a channel measurement on a component carrier associated with network-controlled forwarding. The one or more of the sub-bands may be at least partially overlapping, or may be non-overlapping with a frequency range associated with the serving cell of the NCR-MT 210. The NCR-MT 210 may transmit the sub-band based channel measurements to the network entity 105-a. In some examples, the network entity 105-a may transmit a measurement configuration for the channel measurement. The measurement configuration may include one or more of the following: signal to be measured, frequency-domain information, measurement quantity, or time window for the measurement. For example, the signal to be measured may be a dedicated reference signal or the signal to be forwarded by the NCR-Fwd 215. The frequency-domain information may be a total bandwidth, granularity of a sub-band, or a quantity of sub-bands. In some cases, the granularity of a sub-band may be a fraction of total bandwidth, e.g., a RF band, a RF component carrier, a bandwidth part of a component carrier, or any configured frequency range. The measurement quantity may be one or more of received signal strength indicator (RSSI), reference signal received power (RSRP), reference signal received quality (RSRQ), layer one signal-to-interference plus noise ratio (L1-SINR), channel quality information (CQI), or precoding matrix indicator (PMI). The time window for the channel measurement may be a time window with starting offset or a time window with a periodicity and a starting offset for periodic measurement. The time unit may be in ms, in subframes, slots, or symbols and associated subcarrier spacing. The control signaling 240 may be an RRC message, a MAC-CE message, or DCI message. The network entity 105-a may configure periodic, semi-persistent or aperiodic reporting of the channel measurements, and the network entity 105-a may configure event triggered reporting of the channel measurements (e.g., measurement exceeds some threshold). For example, the NCR 205 may transmit, to the network entity 105-a, the channel measurement 245 associated with the one or more sub-bands. In some cases, the NCR-MT 210 may transmit the channel measurements via the control link 220 to the network entity 105-a. The network entity 105-a may transmit signaling 250 based on the channel measurements, and the NCR 205 may relay the signaling 250 based on the channel measurements.

In some cases, the network entity 105-a may determine which sub-bands to configure for channel measurements over the backhaul link 225 of the NCR-Fwd 215 using various techniques, such as by implementing artificial intelligence (AI) and/or machine learning (ML) techniques. In some examples, the network entity 105-a may use AI and/or or ML techniques to transmit signaling 250 based on the channel measurements. Additionally, the NCR 205 may use AI and/or ML techniques to relay the signaling based on the channel measurements.

In some examples, the network entity 105-a may adapt scheduling decisions for the UE 115-a (or other remote UEs) based on the sub-band based channel feedback for the backhaul link 225. The scheduling decisions by the network entity 105-a for the UE 115-a may include a configuration of bandwidth part of the UE 115-a, a selection of frequency-domain resources for end-to-end channel measurement and/or communication, and imposing maximum limits on the modulation and coding scheme (MCS). For example, the network entity 105-a may configure (e.g., select) the bandwidth part having sufficient quality for the relay. In some cases, the network entity 105-a may adjust transmission power of signals based on the backhaul link 225 channel feedback to avoid PA saturation at the NCR 205.

In some examples, the network entity 105-a may indicate sub-band based control information to the NCR 205 based on the sub-band based channel feedback for backhaul link 225. For example, the NCR 205 may receive, from the network entity 105-a based on the channel measurement, control signaling 255 indicating control information associated with the network-controlled forwarding via the one or more sub-bands. The control signaling 255 may be carried by one or more of RRC, MAC-CE or DCI. The NCR 205 may apply different control information over different sub-bands of the forwarded path. The sub-band based control information may include one or more of: an amplification gain, a transmission power, a maximum limit on amplification gain or transmission power, an on-off operation, backhaul beams, access-link beams, a quantity of reception or transmission antenna elements, or the one or more sub-bands associated with the indicated control information.

In some examples, the NCR 205 may measure other frequencies in an intermediate frequency (IF) domain or a radio frequency domain. For example, the NCR 205 may measure the total received power in the RF or IF domain, such as RSSI. The measurements in the RF and IF domain may not be supported by the UE 115-a and may be suitable for a simple analog NCR that may have very limited baseband processing capabilities. In another example, the NCR-MT 210 may function as a powerful network-node and may be capable of deriving and reporting more detailed metrics, such as PMI and CQI on non-serving frequencies. In some cases, the UE 115-a may not be capable of deriving and reporting the PMI and CQI on non-serving frequencies.

In some examples, when the network entity 105-a indicates the sub-band to be used for an upcoming scheduled forwarding operation, the indicated sub-band information may be used by the NCR 205 to adjust an amplification gain associated with the scheduled forwarding operation. For example, the NCR 205 may have measured channel strength (or peak-to-average power ratio (PAPR)) of the sub-band, and the NCR may autonomously adjust the amplification gain to a better state to avoid PA saturation. The NCR 205 may perform wideband forwarding, and the NCR 205 may not have filtering capability. In some cases, when the network entity 105-a indicates the sub-band to be used for an upcoming scheduled forwarding operation, the NCR 205 may perform a new measurement and update the frequency-selective measurement database.

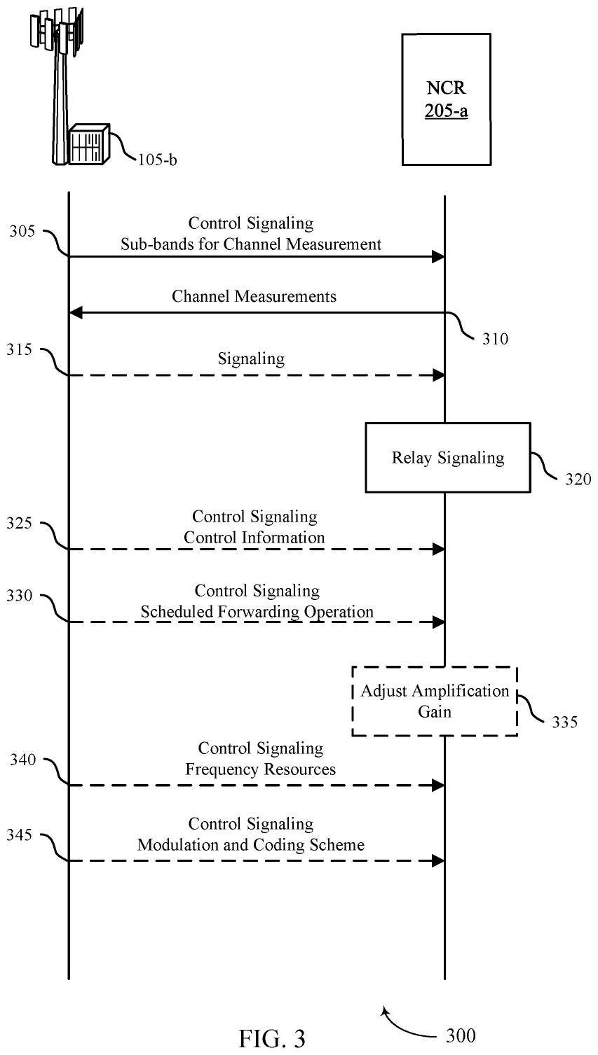

FIG. 3 shows an example of a process flow 300 that supports techniques for determining channel measurements by a NCR in accordance with one or more aspects of the present disclosure. In some examples, the process flow 300 may implement or be implemented by aspects of the wireless communications systems 100 and 200 as described with reference to FIGS. 1 and 2, respectively. For example, the process flow 300 may be implemented by a network entity 105-b, which may be an example of the network entities 105 as described with reference to FIGS. 1 and 2. The process flow 300 may be implemented by a NCR 205-a, which may be an example of the NCR as described with reference to FIG. 2.

In some examples, the operations illustrated in process flow 300 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 305, the NCR 205-a may receive, from the network entity 105-b via a serving cell associated with the NCR 205-a, first control signaling indicating one or more sub-bands for a channel measurement on a component carrier associated with network-controlled forwarding. The one or more sub-bands may be at least partially non-overlapping with a frequency range associated with the serving cell. In some examples, the one or more sub-bands may be a frequency range, a radio frequency band, the component carrier, or a bandwidth part of the component carrier. In some examples, component carriers associated with the one or more sub-bands may not be configured as serving cells for the NCR 205-a (e.g., NCR 205-a may be configured with a single serving cell, and may not be configured with secondary cells (SCells) associated with the one or more sub-bands). In some examples, the channel measurement may be a received signal strength indicator in an intermediate frequency domain or a radio frequency domain. In some cases, the channel measurement may be a precoding matrix indicator or a channel quality indicator.

At 310, the NCR 205-a may transmit, to the network entity 105-b based on receiving the first control signaling, the channel measurement associated with the one or more sub-bands.

At 315, the network entity 105-b may output signaling over the one or more sub-bands based on transmitting the channel measurement. In some examples, the network entity 105-b may adjust a transmission power associated with the signaling based on the channel measurement.

At 320, the NCR 205-a may relay signaling over the one or more sub-bands.

At 325, the NCR 205-a may receive, from the network entity 105-b based on the channel measurement, second control signaling indicating control information associated with the network-controlled forwarding via the one or more sub-bands. In some examples, the control information may indicate an amplification gain, a transmission power, an on-off operation, one or more backhaul beams, one or more access-link beams, a quantity of antenna elements, or a combination thereof.

At 330, the NCR 205-a may receive, from the network entity 105-b based on the channel measurement, third control signaling indicating the one or more sub-bands associated with a scheduled forwarding operation.

At 335, the NCR 205-a may adjust an amplification gain associated with the scheduled forwarding operation.

At 340, the network entity 105-b may output, to a UE via the network-controlled forwarding based on the channel measurement, third control signaling indicating a configuration of a frequency domain resources associated with a second channel measurement or associated with a communication.

At 345, the network entity 105-b may output, to a UE via the network-controlled forwarding based on the channel measurement, third control signaling indicating a configuration of a modulation and coding scheme for communication of data with the UE via the network-controlled forwarding.

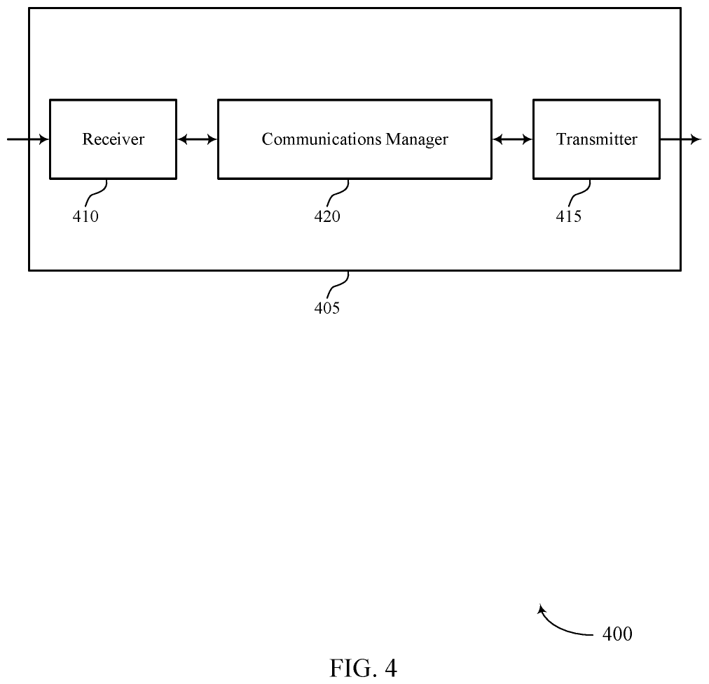

FIG. 4 shows a block diagram 400 of a device 405 that supports techniques for determining channel measurements by a NCR in accordance with one or more aspects of the present disclosure. The device 405 may be an example of aspects of the NCR as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations thereof or various components thereof may be examples of means for performing various aspects of techniques for determining channel measurements by a NCR as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The communications manager 420 is capable of, configured to, or operable to support a means for transmitting, to the network entity based on receiving the first control signaling, the channel measurement associated with the one or more sub-bands. The communications manager 420 is capable of, configured to, or operable to support a means for relaying signaling over the one or more sub-bands based on transmitting the channel measurement.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

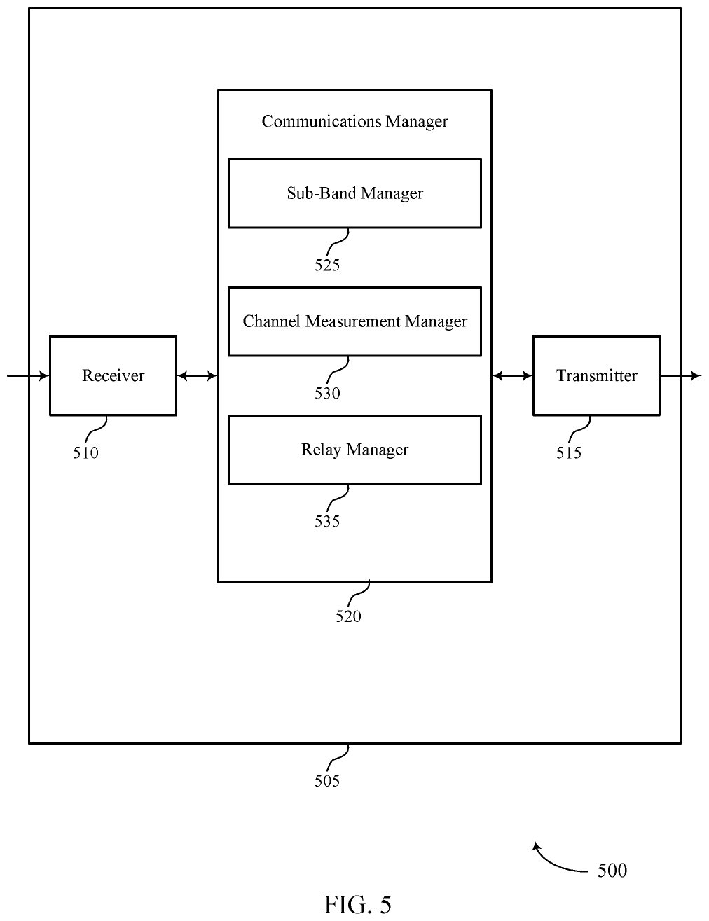

FIG. 5 shows a block diagram 500 of a device 505 that supports techniques for determining channel measurements by a NCR in accordance with one or more aspects of the present disclosure. The device 505 may be an example of aspects of a device 405 or an NCR 205 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505 for processing. In some examples, the receiver 910 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of techniques for determining channel measurements by a NCR as described herein. For example, the communications manager 520 may include a sub-band manager 525, a channel measurement manager 530, a relay manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The sub-band manager 525 is capable of, configured to, or operable to support a means for receiving, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The channel measurement manager 530 is capable of, configured to, or operable to support a means for transmitting, to the network entity based on receiving the first control signaling, the channel measurement associated with the one or more sub-bands. The relay manager 535 is capable of, configured to, or operable to support a means for relaying signaling over the one or more sub-bands based on transmitting the channel measurement.

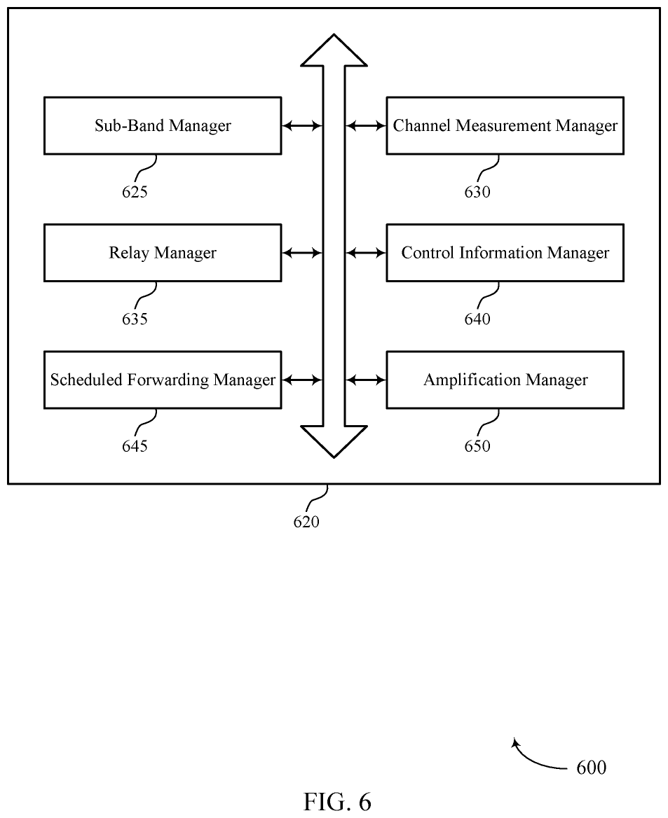

FIG. 6 shows a block diagram 600 of a communications manager 620 that supports techniques for determining channel measurements by a NCR in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for determining channel measurements by a NCR as described herein. For example, the communications manager 620 may include a sub-band manager 625, a channel measurement manager 630, a relay manager 635, a control information manager 640, a scheduled forwarding manager 645, an amplification manager 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The sub-band manager 625 is capable of, configured to, or operable to support a means for receiving, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The channel measurement manager 630 is capable of, configured to, or operable to support a means for transmitting, to the network entity based on receiving the first control signaling, the channel measurement associated with the one or more sub-bands. The relay manager 635 is capable of, configured to, or operable to support a means for relaying signaling over the one or more sub-bands based on transmitting the channel measurement.

In some examples, the one or more sub-bands may be a frequency range, a radio frequency band, the component carrier, or a bandwidth part of the component carrier.

In some examples, the control information manager 640 is capable of, configured to, or operable to support a means for receiving, from the network entity based on the channel measurement, second control signaling indicating control information associated with the network-controlled forwarding via the one or more sub-bands.

In some examples, the control information indicates an amplification gain, a transmission power, an on-off operation, one or more backhaul beams, one or more access-link beams, a quantity of antenna elements, or a combination thereof.

In some examples, the channel measurement includes a received signal strength indicator in an intermediate frequency domain or a radio frequency domain.

In some examples, the channel measurement includes a precoding matrix indicator or a channel quality indicator.

In some examples, the scheduled forwarding manager 645 is capable of, configured to, or operable to support a means for receiving, from the network entity based on transmitting the channel measurement, third control signaling indicating the one or more sub-bands associated with a scheduled forwarding operation. In some examples, the amplification manager 650 is capable of, configured to, or operable to support a means for adjusting an amplification gain associated with the scheduled forwarding operation.

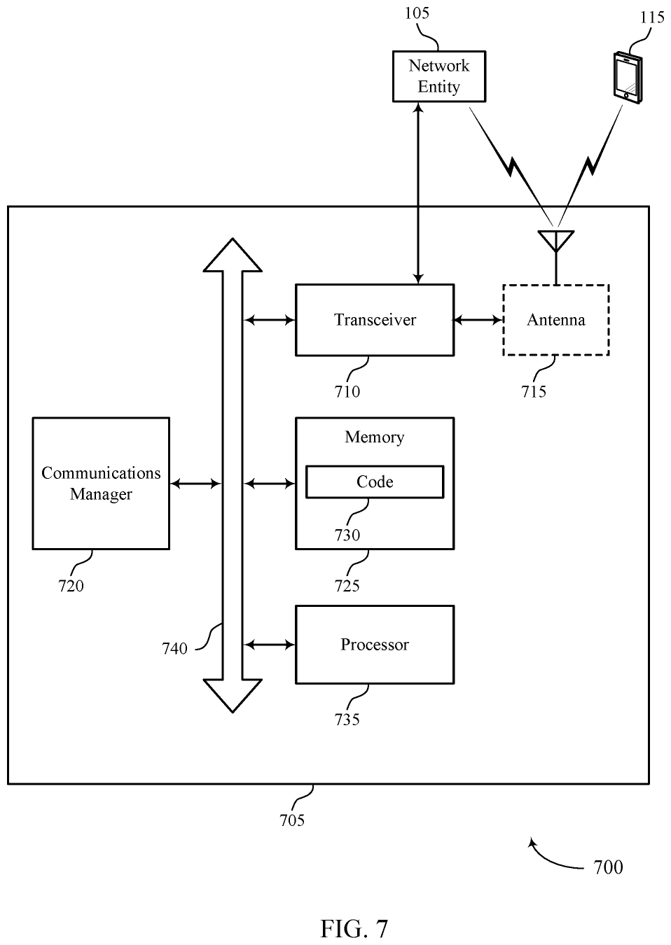

FIG. 7 shows a diagram of a system 700 including a device 705 that supports techniques for determining channel measurements by a NCR in accordance with one or more aspects of the present disclosure. The device 705 may be an example of or include the components of a device 405, a device 505, or an NCR as described herein. The device 705 may include components that support outputting and obtaining communications, such as a communications manager 720, a transceiver 710, an antenna 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., a control link 220, a backhaul link 225, a access link 230).

The at least one memory 725 may include RAM, ROM, or any combination thereof. The at least one memory 725 may store computer-readable, computer-executable code 730 including instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may contain, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting techniques for determining channel measurements by a NCR). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725). In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

The communications manager 720 may support wireless communications in accordance with examples as disclosed herein. For example, the communications manager 720 is capable of, configured to, or operable to support a means for receiving, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The communications manager 720 is capable of, configured to, or operable to support a means for transmitting, to the network entity based on receiving the first control signaling, the channel measurement associated with the one or more sub-bands. The communications manager 720 is capable of, configured to, or operable to support a means for relaying signaling over the one or more sub-bands based on transmitting the channel measurement.

By including or configuring the communications manager 720 in accordance with examples as described herein, the device 705 may support techniques for improved communication reliability, reduced latency, more efficient utilization of communication resources, and improved coordination between devices.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of techniques for determining channel measurements by a NCR as described herein, or the at least one processor 735 and the at least one memory 725 may be otherwise configured to, individually or collectively, perform or support such operations

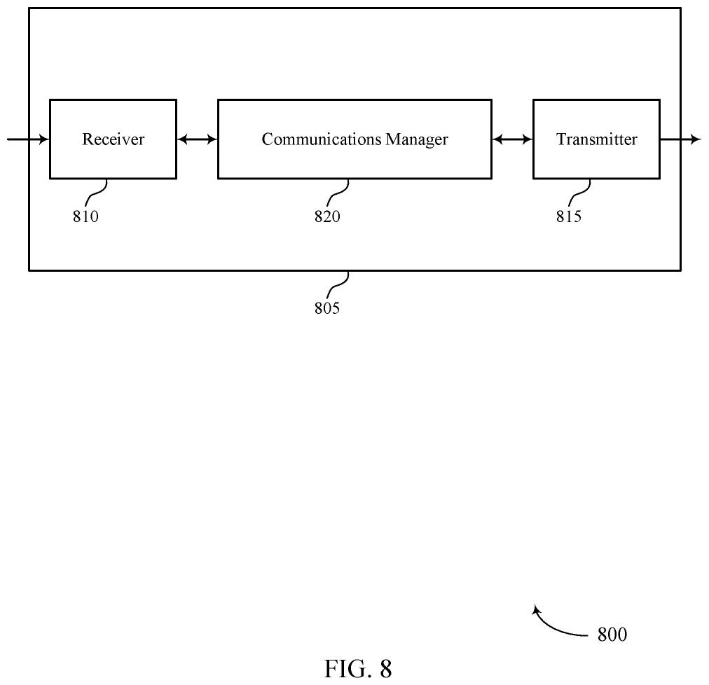

FIG. 8 shows a block diagram 800 of a device 805 that supports techniques for determining channel measurements by a NCR in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of techniques for determining channel measurements by a NCR as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The communications manager 820 is capable of, configured to, or operable to support a means for obtaining, from the network entity based on transmitting the first control signaling, the channel measurement associated with the one or more sub-bands. The communications manager 820 is capable of, configured to, or operable to support a means for outputting signaling over the one or more sub-bands based on transmitting the channel measurement.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

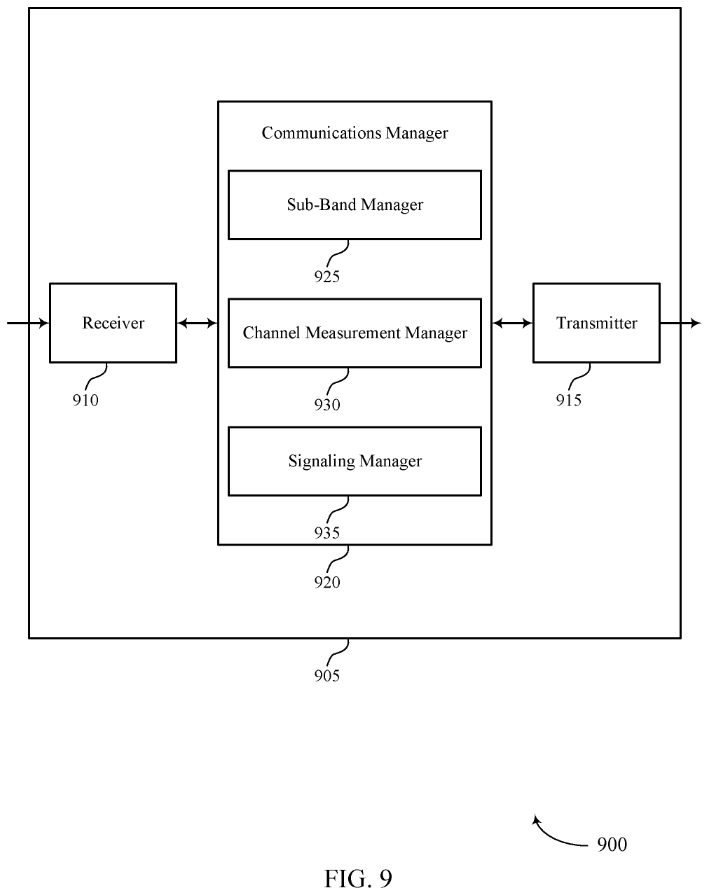

FIG. 9 shows a block diagram 900 of a device 905 that supports techniques for determining channel measurements by a NCR in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for determining channel measurements by a NCR as described herein. For example, the communications manager 920 may include a sub-band manager 925, a channel measurement manager 930, a signaling manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The sub-band manager 925 is capable of, configured to, or operable to support a means for outputting, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The channel measurement manager 930 is capable of, configured to, or operable to support a means for obtaining, from the network entity based on transmitting the first control signaling, the channel measurement associated with the one or more sub-bands. The signaling manager 935 is capable of, configured to, or operable to support a means for outputting signaling over the one or more sub-bands based on transmitting the channel measurement.

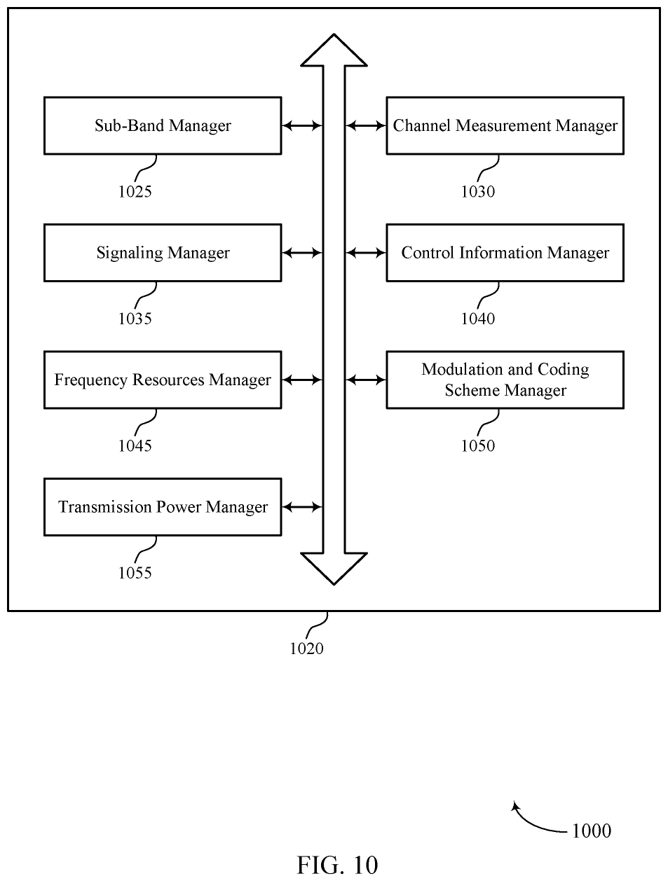

FIG. 10 shows a block diagram 1000 of a communications manager 1020 that supports techniques for determining channel measurements by a NCR in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for determining channel measurements by a NCR as described herein. For example, the communications manager 1020 may include a sub-band manager 1025, a channel measurement manager 1030, a signaling manager 1035, a control information manager 1040, a frequency resources manager 1045, a modulation and coding scheme manager 1050, a transmission power manager 1055, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The sub-band manager 1025 is capable of, configured to, or operable to support a means for outputting, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The channel measurement manager 1030 is capable of, configured to, or operable to support a means for obtaining, from the network entity based on transmitting the first control signaling, the channel measurement associated with the one or more sub-bands. The signaling manager 1035 is capable of, configured to, or operable to support a means for outputting signaling over the one or more sub-bands based on transmitting the channel measurement.

In some examples, the one or more sub-bands may be a frequency range, a radio frequency band, the component carrier, or a bandwidth part of the component carrier.

In some examples, the control information manager 1040 is capable of, configured to, or operable to support a means for outputting, to the NCR based on obtaining the channel measurement, second control signaling indicating control information associated with the network-controlled forwarding via the one or more sub-bands.

In some examples, the control information indicates an amplification gain, a transmission power, an on-off operation, one or more backhaul beams, one or more access-link beams, a quantity of antenna elements.

In some examples, the frequency resources manager 1045 is capable of, configured to, or operable to support a means for outputting, to a user equipment via the network-controlled forwarding based on obtaining the channel measurement, third control signaling indicating a configuration of a frequency domain resources associated with a second channel measurement or associated with a communication.

In some examples, the modulation and coding scheme manager 1050 is capable of, configured to, or operable to support a means for outputting, to a user equipment via the network-controlled forwarding based on obtaining the channel measurement, third control signaling indicating a configuration of a modulation and coding scheme for communication of data with the user equipment via the network-controlled forwarding.

In some examples, the transmission power manager 1055 is capable of, configured to, or operable to support a means for adjusting a transmission power associated with the signaling based on the channel measurement.

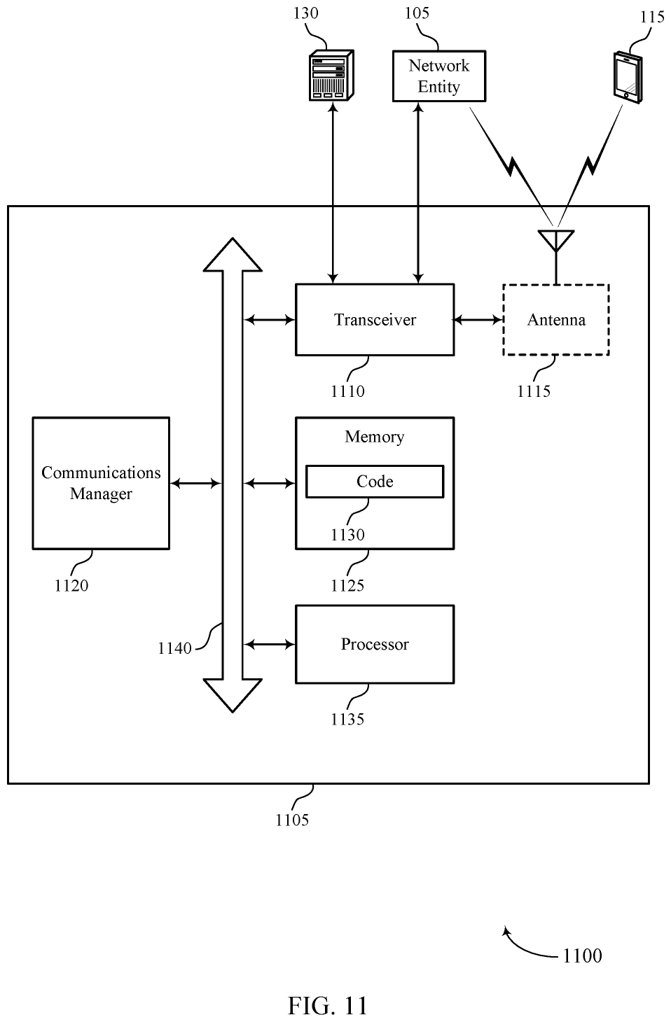

FIG. 11 shows a diagram of a system 1100 including a device 1105 that supports techniques for determining channel measurements by a NCR in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for determining channel measurements by a NCR). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The communications manager 1120 is capable of, configured to, or operable to support a means for obtaining, from the network entity based on transmitting the first control signaling, the channel measurement associated with the one or more sub-bands. The communications manager 1120 is capable of, configured to, or operable to support a means for outputting signaling over the one or more sub-bands based on transmitting the channel measurement.

By including or configuring the communications manager 1120 in accordance with examples as described herein, the device 1105 may support techniques for improved communication reliability, reduced latency, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for determining channel measurements by a NCR as described herein, or the at least one processor 1135 and the at least one memory 1125 may be otherwise configured to, individually or collectively, perform or support such operations.

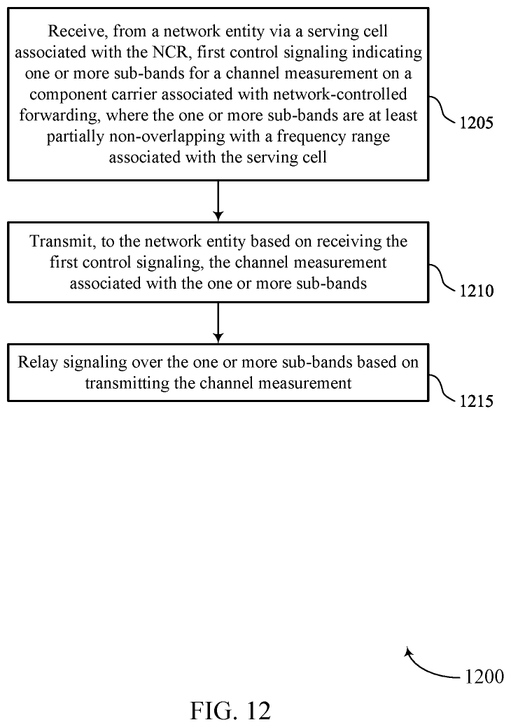

FIG. 12 shows a flowchart illustrating a method 1200 that supports techniques for determining channel measurements by a NCR in accordance with one or more aspects of the present disclosure. The operations of the method 1200 may be implemented by an NCR or its components as described herein. For example, the operations of the method 1200 may be performed by an NCR as described with reference to FIGS. 1 through 7. In some examples, an NCR may execute a set of instructions to control the functional elements of the NCR to perform the described functions. Additionally, or alternatively, the NCR may perform aspects of the described functions using special-purpose hardware.

At 1205, the method may include receiving, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The operations of block 1205 may be performed in accordance with examples as disclosed herein. In some examples, aspects of the operations of 1205 may be performed by a sub-band manager 625 as described with reference to FIG. 6.

At 1210, the method may include transmitting, to the network entity based on receiving the first control signaling, the channel measurement associated with the one or more sub-bands. The operations of block 1210 may be performed in accordance with examples as disclosed herein. In some examples, aspects of the operations of 1210 may be performed by a channel measurement manager 630 as described with reference to FIG. 6.

At 1215, the method may include relaying signaling over the one or more sub-bands based on transmitting the channel measurement. The operations of block 1215 may be performed in accordance with examples as disclosed herein. In some examples, aspects of the operations of 1215 may be performed by a relay manager 635 as described with reference to FIG. 6.

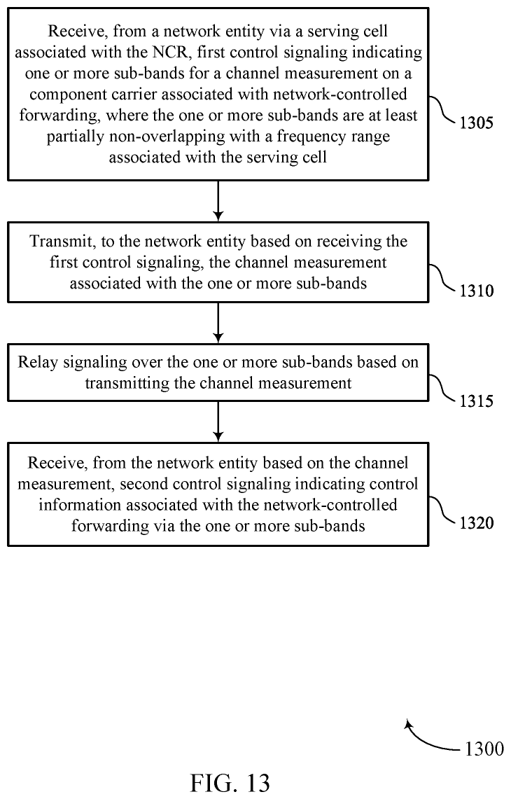

FIG. 13 shows a flowchart illustrating a method 1300 that supports techniques for determining channel measurements by a NCR in accordance with one or more aspects of the present disclosure. The operations of the method 1300 may be implemented by an NCR or its components as described herein. For example, the operations of the method 1300 may be performed by an NCR as described with reference to FIGS. 1 through 7. In some examples, an NCR may execute a set of instructions to control the functional elements of the NCR to perform the described functions. Additionally, or alternatively, the NCR may perform aspects of the described functions using special-purpose hardware.

At 1305, the method may include receiving, from a network entity via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The operations of block 1305 may be performed in accordance with examples as disclosed herein. In some examples, aspects of the operations of 1305 may be performed by a sub-band manager 625 as described with reference to FIG. 6.

At 1310, the method may include transmitting, to the network entity based on receiving the first control signaling, the channel measurement associated with the one or more sub-bands. The operations of block 1310 may be performed in accordance with examples as disclosed herein. In some examples, aspects of the operations of 1310 may be performed by a channel measurement manager 630 as described with reference to FIG. 6.

At 1315, the method may include relaying signaling over the one or more sub-bands based on transmitting the channel measurement. The operations of block 1315 may be performed in accordance with examples as disclosed herein. In some examples, aspects of the operations of 1315 may be performed by a relay manager 635 as described with reference to FIG. 6.

At 1320, the method may include receiving, from the network entity based on the channel measurement, second control signaling indicating control information associated with the network-controlled forwarding via the one or more sub-bands. The operations of block 1320 may be performed in accordance with examples as disclosed herein. In some examples, aspects of the operations of 1320 may be performed by a control information manager 640 as described with reference to FIG. 6.

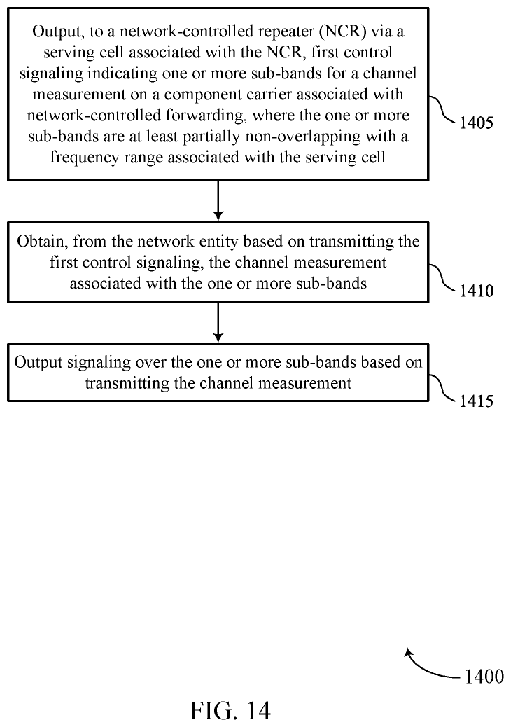

FIG. 14 shows a flowchart illustrating a method 1400 that supports techniques for determining channel measurements by a NCR in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting, to a NCR via a serving cell associated with the NCR, first control signaling indicating one or more sub-bands for a channel measurement on a component carrier associated with network-controlled forwarding, where the one or more sub-bands are at least partially non-overlapping with a frequency range associated with the serving cell. The operations of block 1405 may be performed in accordance with examples as disclosed herein. In some examples, aspects of the operations of 1405 may be performed by a sub-band manager 1025 as described with reference to FIG. 10.

At 1410, the method may include obtaining, from the network entity based on transmitting the first control signaling, the channel measurement associated with the one or more sub-bands. The operations of block 1410 may be performed in accordance with examples as disclosed herein. In some examples, aspects of the operations of 1410 may be performed by a channel measurement manager 1030 as described with reference to FIG. 10.

At 1415, the method may include outputting signaling over the one or more sub-bands based on transmitting the channel measurement. The operations of block 1415 may be performed in accordance with examples as disclosed herein. In some examples, aspects of the operations of 1415 may be performed by a signaling manager 1035 as described with reference to FIG. 10.

The following provides an overview of aspects of the present disclosure:

Aspect 1: A method for wireless communications by a NCR, comprising: receiving, from a network entity via a serving cell associated with the NCR, first control signaling indicating one or more sub-bands for a channel measurement on a component carrier associated with network-controlled forwarding, wherein the one or more sub-bands are at least partially non-overlapping with a frequency range associated with the serving cell; transmitting, to the network entity based at least in part on receiving the first control signaling, the channel measurement associated with the one or more sub-bands; and relaying signaling over the one or more sub-bands based at least in part on transmitting the channel measurement.

Aspect 2: The method of aspect 1, wherein the one or more sub-bands may be a frequency range, a radio frequency band, the component carrier, or a bandwidth part of the component carrier.

Aspect 3: The method of any of aspects 1 through 2, further comprising: receiving, from the network entity based at least in part on the channel measurement, second control signaling indicating control information associated with the network-controlled forwarding via the one or more sub-bands.

Aspect 4: The method of aspect 3, wherein the control information indicates an amplification gain, a transmission power, an on-off operation, one or more backhaul beams, one or more access-link beams, a quantity of antenna elements, or a combination thereof.

Aspect 5: The method of any of aspects 1 through 4, wherein the channel measurement comprises a received signal strength indicator in an intermediate frequency domain or a radio frequency domain.

Aspect 6: The method of any of aspects 1 through 5, wherein the channel measurement comprises a precoding matrix indicator or a channel quality indicator.

Aspect 7: The method of any of aspects 1 through 6, further comprising: receiving, from the network entity based at least in part on transmitting the channel measurement, third control signaling indicating the one or more sub-bands associated with a scheduled forwarding operation; and adjusting an amplification gain associated with the scheduled forwarding operation.

Aspect 8: A method for wireless communications by a network entity, comprising: outputting, to a NCR via a serving cell associated with the NCR, first control signaling indicating one or more sub-bands for a channel measurement on a component carrier associated with network-controlled forwarding, wherein the one or more sub-bands are at least partially non-overlapping with a frequency range associated with the serving cell; obtaining, from the network entity based at least in part on transmitting the first control signaling, the channel measurement associated with the one or more sub-bands; and outputting signaling over the one or more sub-bands based at least in part on transmitting the channel measurement.

Aspect 9: The method of aspect 8, wherein the one or more sub-bands may be a frequency range, a radio frequency band, the component carrier, or a bandwidth part of the component carrier.

Aspect 10: The method of any of aspects 8 through 9, further comprising: outputting, to the NCR based at least in part on obtaining the channel measurement, second control signaling indicating control information associated with the network-controlled forwarding via the one or more sub-bands.

Aspect 11: The method of aspect 10, wherein the control information indicates an amplification gain, a transmission power, an on-off operation, one or more backhaul beams, one or more access-link beams, a quantity of antenna elements.

Aspect 12: The method of any of aspects 8 through 11, further comprising: outputting, to a user equipment via the network-controlled forwarding based at least in part on obtaining the channel measurement, third control signaling indicating a configuration of a frequency domain resources associated with a second channel measurement or associated with a communication.

Aspect 13: The method of any of aspects 8 through 12, further comprising: outputting, to a user equipment via the network-controlled forwarding based at least in part on obtaining the channel measurement, third control signaling indicating a configuration of a modulation and coding scheme for communication of data with the user equipment via the network-controlled forwarding.

Aspect 14: The method of any of aspects 8 through 13, further comprising: adjusting a transmission power associated with the signaling based at least in part on the channel measurement.

Aspect 15: A NCR for wireless communications, comprising one or more memories storing processor-executable code, and one or more processors coupled with the one or more memories and individually or collectively operable to execute the code to cause the NCR to perform a method of any of aspects 1 through 7.

Aspect 16: A NCR for wireless communications, comprising at least one means for performing a method of any of aspects 1 through 7.

Aspect 17: A non-transitory computer-readable medium storing code for wireless communications, the code comprising instructions executable by one or more processors to perform a method of any of aspects 1 through 7.

Aspect 18: A network entity for wireless communications, comprising one or more memories storing processor-executable code, and one or more processors coupled with the one or more memories and individually or collectively operable to execute the code to cause the network entity to perform a method of any of aspects 8 through 14.

Aspect 19: A network entity for wireless communications, comprising at least one means for performing a method of any of aspects 8 through 14.

Aspect 20: A non-transitory computer-readable medium storing code for wireless communications, the code comprising instructions executable by one or more processors to perform a method of any of aspects 8 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network-controlled repeater (NCR), comprising:
one or more memories storing processor-executable code; and
one or more processors coupled with the one or more memories and individually or collectively operable to execute the code to cause the NCR to:
receive, from a network entity via a serving cell associated with the NCR, first control signaling indicating one or more sub-bands for a channel measurement on a component carrier associated with network-controlled forwarding, wherein the one or more sub-bands are at least partially non-overlapping with a frequency range associated with the serving cell;
transmit, to the network entity based at least in part on reception of the first control signaling, the channel measurement associated with the one or more sub-bands; and
relay signaling over the one or more sub-bands based at least in part on transmitting the channel measurement.

2. The NCR of claim 1, wherein the one or more sub-bands correspond to a frequency range, a radio frequency band, the component carrier, or a bandwidth part of the component carrier.

3. The NCR of claim 1, wherein the one or more processors are individually or collectively further operable to execute the code to cause the NCR to:
receive, from the network entity based at least in part on the channel measurement, second control signaling indicating control information associated with the network-controlled forwarding via the one or more sub-bands.

4. The NCR of claim 3, wherein the control information indicates an amplification gain, a transmission power, an on-off operation, one or more backhaul beams, one or more access-link beams, a quantity of antenna elements, or a combination thereof.

5. The NCR of claim 1, wherein the channel measurement comprises a received signal strength indicator in an intermediate frequency domain or a radio frequency domain.

6. The NCR of claim 1, wherein the channel measurement comprises a precoding matrix indicator or a channel quality indicator.

7. The NCR of claim 1, wherein the one or more processors are individually or collectively further operable to execute the code to cause the NCR to:
receive, from the network entity based at least in part on transmission of the channel measurement, third control signaling indicating the one or more sub-bands associated with a scheduled forwarding operation; and
adjust an amplification gain associated with the scheduled forwarding operation.

8. A network entity, comprising:
one or more memories storing processor-executable code; and
one or more processors coupled with the one or more memories and individually or collectively operable to execute the code to cause the network entity to:
output, to a network-controlled repeater (NCR) via a serving cell associated with the NCR, first control signaling indicating one or more sub-bands for a channel measurement on a component carrier associated with network-controlled forwarding, wherein the one or more sub-bands are at least partially non-overlapping with a frequency range associated with the serving cell;
obtain, from the network entity based at least in part on output of the first control signaling, the channel measurement associated with the one or more sub-bands; and
output signaling over the one or more sub-bands based at least in part on the channel measurement.

9. The network entity of claim 8, wherein the one or more sub-bands correspond to a frequency range, a radio frequency band, the component carrier, or a bandwidth part of the component carrier.

10. The network entity of claim 8, wherein the one or more processors are individually or collectively further operable to execute the code to cause the network entity to:
output, to the NCR based at least in part on the channel measurement, second control signaling indicating control information associated with the network-controlled forwarding via the one or more sub-bands.

11. The network entity of claim 10, wherein the control information indicates an amplification gain, a transmission power, an on-off operation, one or more backhaul beams, one or more access-link beams, a quantity of antenna elements.

12. The network entity of claim 8, wherein the one or more processors are individually or collectively further operable to execute the code to cause the network entity to:
output, to a user equipment via the network-controlled forwarding based at least in part on the channel measurement, third control signaling indicating a configuration of a frequency domain resources associated with a second channel measurement or associated with a communication.

13. The network entity of claim 8, wherein the one or more processors are individually or collectively further operable to execute the code to cause the network entity to:
output, to a user equipment via the network-controlled forwarding based at least in part on the channel measurement, third control signaling indicating a configuration of a modulation and coding scheme for communication of data with the user equipment via the network-controlled forwarding.

14. The network entity of claim 8, wherein the one or more processors are individually or collectively further operable to execute the code to cause the network entity to:
adjust a transmission power associated with the signaling based at least in part on the channel measurement.

15. A method for wireless communications by a network-controlled repeater (NCR), comprising:
receiving, from a network entity via a serving cell associated with the NCR, first control signaling indicating one or more sub-bands for a channel measurement on a component carrier associated with network-controlled forwarding, wherein the one or more sub-bands are at least partially non-overlapping with a frequency range associated with the serving cell;
transmitting, to the network entity based at least in part on receiving the first control signaling, the channel measurement associated with the one or more sub-bands; and
relaying signaling over the one or more sub-bands based at least in part on transmitting the channel measurement.

16. The method of claim 15, wherein the one or more sub-bands correspond to a frequency range, a radio frequency band, the component carrier, or a bandwidth part of the component carrier.

17. The method of claim 15, further comprising:
receiving, from the network entity based at least in part on the channel measurement, second control signaling indicating control information associated with the network-controlled forwarding via the one or more sub-bands.

18. The method of claim 17, wherein the control information indicates an amplification gain, a transmission power, an on-off operation, one or more backhaul beams, one or more access-link beams, a quantity of antenna elements, or a combination thereof.

19. The method of claim 15, wherein the channel measurement comprises a received signal strength indicator in an intermediate frequency domain or a radio frequency domain.

20. The method of claim 15, further comprising:
receiving, from the network entity based at least in part on transmitting the channel measurement, third control signaling indicating the one or more sub-bands associated with a scheduled forwarding operation; and
adjusting an amplification gain associated with the scheduled forwarding operation.
